(19) United States
(12) Patent Application Publication
(10) Pub. No.: US 2025/0087792 A1
(43) Pub. Date: Mar. 13, 2025

(54) SECONDARY BATTERY

(71) Applicant: Samsung SDI Co., Ltd., Yongin-si (KR)

(72) Inventors: Soo Min BAEK, Yongin-si (KR); Yeon Ho JUNG, Yongin-si (KR)

(21) Appl. No.: 18/438,302

(22) Filed: Feb. 9, 2024

(30) Foreign Application Priority Data
Sep. 11, 2023 (KR) 10-2023-0120121

(51) Int. Cl. H01M 50/14; H01M 50/103; H01M 50/122; H01M 50/489

(52) U.S. Cl. CPC H01M 50/14; H01M 50/103; H01M 50/122; H01M 50/489; H01M 2200/20

(57) ABSTRACT

A secondary battery in which an electrode assembly is protected or substantially protected from external impact is provided. The secondary battery includes: an electrode assembly including a positive electrode plate and a negative electrode plate; a positive electrode current collector plate electrically connected to the positive electrode plate; a negative electrode current collector plate electrically connected to the negative electrode plate; a case accommodating the electrode assembly, the positive electrode current collector plate, and the negative electrode current collector plate; a positive electrode retainer in a gap between the positive electrode current collector plate and the case, the positive electrode retainer being to ignite and expand upon external impact; and a negative electrode retainer in a gap between the negative electrode current collector plate and the case, the negative electrode retainer being to ignite and expand upon external impact.

### CROSS-REFERENCE TO RELATED APPLICATION

The present application claims priority to and the benefit of Korean Patent Application No. 10-2023-0120121, filed on Sep. 11, 2023, in the Korean Intellectual Property Office, the entire content of which is hereby incorporated by reference.

### BACKGROUND

### 1. Field

Embodiments of the present disclosure relate to a secondary battery.

### 2. Description of the Related Art

Lithium ion secondary batteries are being utilized as power sources for hybrid vehicles and electric vehicles, as well as for portable electronic devices, due to their ability to, for example, operate at relatively high voltages and have relatively high energy densities per unit weight. Secondary batteries can be classified in shape as prismatic, cylindrical, or pouch-shaped. For example, a prismatic secondary battery generally includes a prismatic case, a hexahedral electrode assembly coupled to the case, an electrolyte (optional) that is injected into the inside of the case to enable movement of lithium ions, and a cap plate that is coupled to one side of the case to prevent or reduce electrolyte leakage and to prevent or reduce the likelihood of the electrode assembly from being separated, and a terminal that is electrically connected to the electrode assembly and that penetrates the cap plate.

The above information disclosed in this Background section is only for enhancement of understanding of the background of the disclosure and therefore it may contain information that does not constitute prior art.

### SUMMARY

Aspects of one or more embodiments of the present disclosure relate to a secondary battery in which an electrode assembly is protected from external impact by placing a retainer that ignites and expands upon external impact in a gap between the electrode assembly and a case.

Additional aspects will be set forth in part in the description which follows and, in part, will be apparent from the description, or may be learned by practice of the presented embodiments of the disclosure.

A secondary battery according to one or more embodiments of the present disclosure includes: an electrode assembly including a positive electrode plate and a negative electrode plate; a positive electrode current collector plate electrically connected to the positive electrode plate; a negative electrode current collector plate electrically connected to the negative electrode plate; a case accommodating the electrode assembly, the positive electrode current collector plate, and the negative electrode current collector plate; a positive electrode retainer in a gap between the positive electrode current collector plate and the case, the positive electrode retainer being to ignite and expand upon external impact; and a negative electrode retainer in a gap between the negative electrode current collector plate and the case, the negative electrode retainer being to ignite and expand upon external impact.

In one or more embodiments, the electrode assembly may include a pair of opposing assembly short sides and a pair of assembly long sides connected to the pair of assembly short sides, case may include a pair of opposing case short sides and a pair of case long sides connected to the pair of case short sides, the positive electrode current collector plate may be between one assembly short side and one case short side, and the negative electrode current collector plate may be between the other assembly short side and the other case short side.

In one or more embodiments, the positive electrode retainer may be between the positive electrode current collector plate and the one case short side, and the negative electrode retainer may be between the negative electrode current collector plate and the other case short side.

In one or more embodiments, the electrode assembly may further include an assembly bottom connecting the pair of assembly short sides and the pair of assembly long sides, the case may further include a case bottom connecting the pair of case short sides and the pair of case long sides, and a bottom retainer in a gap between the assembly bottom and the case bottom, the bottom retainer being to ignite and expand upon external impact may be included.

In one or more embodiments, each of the positive electrode retainer and the negative electrode retainer may include: an ignition device; a pair of plate structures outside the ignition device, one plate structure facing the electrode assembly and the other plate structure facing the case; and a gas generator around the ignition device inside the pair of plate structures.

In one or more embodiments, the ignition device may be attached to either one of the pair of plate structures.

In one or more embodiments, the plate structures may include nylon, polyester, polypropylene, and/or polyethylene.

In one or more embodiments, the ignition device may include: a piezoelectric element; a spark generating circuit electrically connected to opposite sides of the piezoelectric element; and an igniter connected to the spark generating circuit.

In one or more embodiments, the secondary battery may further include at least one elastic member within the pair of plate structures.

In one or more embodiments, the elastic member may include (e.g., be) a spring and/or a rubber.

In one or more embodiments, the pair of plate structures may be to press (e.g., provide pressure or pressurize) the ignition device upon external impact (e.g., may press the elastic member and may ultimately press the ignition device).

In one or more embodiments, the gas generating agent may include a sodium azide (NaN₃) capsule and iron oxide (Fe₂O₃).

### BRIEF DESCRIPTION OF DRAWINGS

FIG. 1 is a perspective view showing an example secondary battery according to one or more embodiments of the present disclosure.

FIGS. 2A and 2B are schematic cross-sectional diagrams showing the configuration and operation of an example secondary battery according to one or more embodiments of the present disclosure.

FIGS. 3A and 3B are schematic cross-sectional diagrams showing the operation of an example secondary battery according to one or more embodiments of the present disclosure.

FIGS. 4A and 4B are schematic diagrams showing the configuration and operation of a retainer of an example secondary battery according to one or more embodiments of the present disclosure.

FIG. 5 is a schematic perspective diagram illustrating an example battery pack to which an example secondary battery according to one or more embodiments of the present disclosure is applied.

FIG. 6 is a schematic diagram showing an electric vehicle to which an example battery pack according to one or more embodiments of the present disclosure is applied.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Hereinafter, example embodiments of the present disclosure will be described in more detail with reference to the accompanying drawings.

Embodiments of the present disclosure are provided to more fully describe the present disclosure to those skilled in the art, and the following embodiments may be embodied in many different forms and should not be construed as being limited to the example embodiments set forth herein. Rather, these example embodiments are provided so that this disclosure will be thorough and complete and will convey the aspects and features of the present disclosure to those skilled in the art. Accordingly, processes, elements, and techniques that are not necessary to those having ordinary skill in the art for a complete understanding of the aspects and features of the present disclosure may not be described.

In addition, in the accompanying drawings, sizes or thicknesses of various components may be exaggerated for brevity and/or clarity. Unless otherwise noted, like numbers refer to like elements throughout, and duplicative descriptions thereof may not be provided.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “and/or” includes any and all combinations of one or more of the associated listed items.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises,” “comprising,” “includes,” and “including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms “first,” “second,” etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section, without departing from the spirit and scope of the present disclosure.

Spatially relative terms, such as “beneath,” “below,” “lower,” “above,” “upper,” and the like, may be used herein for ease of description to describe one element or feature's relationship to another element(s) or feature(s) as illustrated in the drawings. It will be understood that the spatially relative terms are intended to encompass different orientations of the device in use or operation, in addition to the orientation depicted in the drawings. For example, if the element or feature in the drawings is turned over, elements described as “below” or “beneath” other elements or features would then be oriented “on” or “above” the other elements or features. Thus, the example term “below” can encompass both an orientation of above and below. The device may be otherwise oriented (e.g., rotated 90 degrees or at other orientations) and the spatially relative descriptors used herein should be interpreted accordingly.

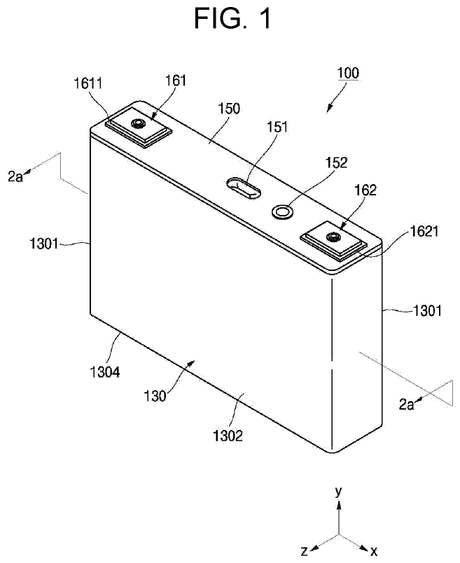

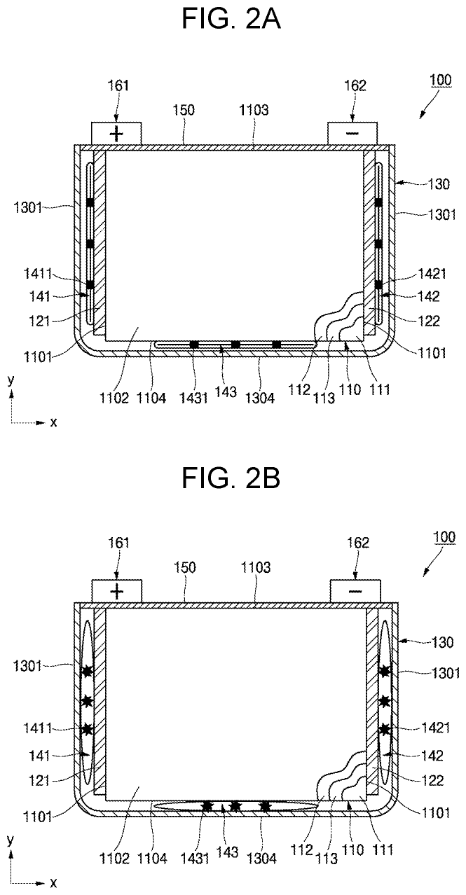

FIG. 1 is a perspective view showing an example secondary battery 100 according to one or more embodiments of the present disclosure, and FIGS. 2A and 2B are schematic cross-sectional diagrams showing the configuration and operation of an example secondary battery 100 according to one or more embodiments of the present disclosure. Here, FIG. 2A shows the state of retainers 141, 142 or 143 before operation, and FIG. 2B shows the state of retainers 141, 142 or 143 after operation. In one or more embodiments, in FIGS. 2A and 2B, the feature of the present disclosure lies in the retainers 141, 142 or 143, and thus the mutual coupling structure of terminals 161 and 162 and current collector plates 121 and 122 and the cross-sectional structure of a cap plate 150 are simply shown.

As shown in FIGS. 1, 2A, and 2B, the example secondary battery 100 according to one or more embodiments of the present disclosure may include an electrode assembly 110, a positive electrode current collector plate 121, a negative electrode current collector plate 122, a case 130, a positive electrode retainer 141, and a negative electrode retainer 142. The example secondary battery 100 according to one or more embodiments of the present disclosure may further include a bottom retainer 143. The example secondary battery 100 according to one or more embodiments of the present disclosure may further include a cap plate 150 covering the case 130. The example secondary battery 100 according to one or more embodiments of the present disclosure may further include a positive electrode terminal 161 and/or a negative electrode terminal 162 coupled through the case 130.

The electrode assembly 110 may have a substantially hexahedral shape. The electrode assembly 110 may include or be referred to as an electrode, an electrode group, or a jellyroll. In one or more embodiments, the electrode assembly 110 may include a positive electrode plate 111, a negative electrode plate 112, and a separator 113 (optional) interposed between the positive electrode plate 111 and the negative electrode plate 112. The electrode assembly 110 may include a pair of opposing assembly short sides 1101, a pair of assembly long sides 1102 that connect the pair of assembly short sides 1101, a pair of assembly short sides 1101, an assembly-upper side 1103 that connects the pair of assembly short sides 1101 and the pair of assembly long sides 1102 at the upper side, and an assembly bottom 1104 that connects the pair of assembly short sides 1101 and the pair of assembly long sides 1102 at the lower side.

In one or more embodiments, the electrode assembly 110 may be a winding type or kind in which the positive electrode plate 111, the separator 113, and the negative electrode plate 112 are stacked and wound multiple times. In one or more embodiments, the winding axis may be parallel to the longitudinal direction of the cap plate 150 or perpendicular (normal) to the longitudinal direction of the cap plate 150. In one or more embodiments, the electrode assembly 110 may be a stack type or kind in which the positive electrode plate 111, the separator 113, and the negative electrode plate 112 are stacked multiple times in that order. In one or more embodiments, the electrode assembly 110 may be a Z-stack type or kind in which the positive electrode plate 111 and the negative electrode plate 112 are positioned above and below the Z-shaped separator 113, respectively.

In one or more embodiments, the positive electrode plate 111 may be formed by coating a positive electrode active material (e.g., a transition metal oxide (LiCoO₂, LiNiO₂, LiMn₂O₄, etc.)) on a positive electrode current collector, and the negative electrode plate 112 may be formed by coating a negative electrode active material (e.g., graphite, carbon, etc.) on a negative electrode current collector. The separator 113 is interposed between the positive electrode plate 111 and the negative electrode plate 112 to prevent or reduce the likelihood of a short circuit between the positive electrode plate 111 and the negative electrode plate 112 and allow the movement of lithium ions (e.g., to only allow the movement of ions, e.g., lithium ions to pass through, while, e.g., blocking electrons). In one or more embodiments, the positive electrode current collector may include aluminum or an aluminum alloy, the negative electrode current collector may include copper, copper alloy, nickel, or a nickel alloy, and the separator 113 may include polyethylene (PE) or propylene (PP). In one or more embodiments, the positive electrode plate 111 may further include a positive electrode uncoated portion that protrudes and extends a certain length from the positive electrode current collector to one side (e.g., the left side). In one or more embodiments, the negative electrode plate 112 may further include a negative electrode uncoated portion that protrudes and extends a certain length from the negative electrode current collector to the other side (e.g., the right side).

In one or more embodiments, the electrode assembly 110 may be accommodated in the case 130 along with an electrolyte. The electrolyte may contain organic solvents such as ethylene carbonate (EC), propylene carbonate (PC), diethyl carbonate (DEC), ethyl methyl carbonate (EMC), and/or dimethyl carbonate (DMC), and lithium salts such as LiPF₆ and/or LiBF₄. In one or more embodiments, the electrolyte may be liquid, solid, or gel. In one or more embodiments, when a solid electrolyte is utilized, the separator may not be provided. In one or more embodiments, the solid electrolyte may include a sulfide-based, oxide-based, or polymer-based electrolyte.

The positive electrode current collector plate 121 may be electrically connected to the positive electrode plate 111 of the electrode assembly 110. In one or more embodiments, the positive electrode current collector plate 121 may be laser or ultrasonic welded to the positive electrode uncoated portion. The positive electrode current collector plate 121 may be positioned in a vertical direction between a gap between one assembly short side 1101 of the electrode assembly 110 and one case short side 1301 of the case 130. The positive electrode current collector plate 121 may be referred to as a positive electrode current collector, a positive electrode conductor, or a positive electrode sub-plate. The positive electrode current collector plate 121 may be electrically connected to the positive electrode terminal 161, which will be described in more detail below. The positive electrode current collector plate 121 may include aluminum or an aluminum alloy. In one or more embodiments, the positive electrode current collector plate 121 may provide a current path between the positive electrode terminal 161 and the electrode assembly 110.

The negative electrode current collector plate 122 may be electrically connected to the negative electrode plate 112 of the electrode assembly 110. In one or more embodiments, the negative electrode current collector plate 122 may be laser or ultrasonic welded to the negative electrode uncoated portion. The negative electrode current collector plate 122 may be positioned in a vertical direction (e.g., a thickness direction) between a gap between the other assembly short side 1101 of the electrode assembly 110 and the other case short side 1301 of the case 130. The negative electrode current collector plate 122 may be referred to as a negative electrode current collector, a negative electrode conductor, or a negative electrode subplate. The negative electrode current collector plate 122 may be electrically connected to the negative electrode terminal 162, which will be described in more detail below. The negative electrode current collector plate 122 may include copper, a copper alloy, nickel, or a nickel alloy. In one or more embodiments, the negative electrode current collector plate 122 may provide a current path between the negative electrode terminal 162 and the electrode assembly 110.

The case 130 can accommodate the electrode assembly 110, the positive electrode current collector plate 121, the negative electrode current collector plate 122, and an electrolyte (or solid electrolyte). The case 130 may include or be referred to as an exterior material, a housing, or a can. The case 130 may be provided in a substantially hexahedral shape with an open top. The case 130 has a pair of opposing case short sides 1301, a pair of case long sides 1302 connecting the pair of case short sides 1301, and a case bottom 1304 that connects the pair of case short sides 1301 and the pair of case long sides 1302 at the lower side. The upper region of the case 130 opposite the case bottom 1304 may be closed with the cap plate 150, which will be described in more detail below. The case 130 may include aluminum, an aluminum alloy, or nickel-plated steel.

The positive electrode retainer 141 may be positioned in a vertical direction in a gap between the positive electrode current collector plate 121 and one case short side 1301. In one or more embodiments, the positive electrode retainer 141 may be coupled to the positive electrode current collector plate 121 and/or one assembly short side 1101 by a mechanical structure in an insulated state. In one or more embodiments, the positive electrode retainer 141 may contact the positive electrode current collector plate 121 or one assembly short side 1101 and be spaced and/or apart (e.g., spaced, apart and/or separated) from the one case short side 1301. In one or more embodiments, the positive electrode retainer 141 may loosely contact the one case short side 1301 (e.g., a side of the positive electrode retainer 141 adjacent the one case short side 1301 may partially or not fully contact the one case short side 1301). In one or more embodiments, the vertical length of the positive electrode retainer 141 may be smaller than the vertical length of the positive electrode current collector plate 121. In one or more embodiments, the vertical length of the positive electrode retainer 141 may be equal to or greater than the vertical length of the positive electrode current collector plate 121. The positive electrode retainer 141 may also be referred to as a positive electrode insulator, a positive electrode elastomer, a positive electrode spacer, or a positive electrode stopper. The positive electrode retainer 141 can basically prevent or reduce the positive electrode current collector plate 121 and/or the electrode assembly 110 from directly contacting or short-circuiting the one case short side 1301. The positive electrode retainer 141 ignites and expands upon external impact, thereby preventing or reducing the positive electrode current collector plate 121 and/or the electrode assembly 110 from directly contacting the one case short side 1301. In one or more embodiments, a plurality of positive electrode side ignition devices 1411 may be arranged inside the positive electrode retainer 141.

The negative electrode side retainer 142 may be positioned in a vertical direction in a gap between the negative electrode current collector plate 122 and the other case short side 1301. In one or more embodiments, the negative electrode side retainer 142 may be coupled to the negative electrode current collector plate 122 and/or the other assembly short side 1101 by a mechanical structure in an insulated state. In one or more embodiments, the negative electrode side retainer 142 may contact the negative electrode current collector plate 122 or the other assembly short side 1101 and be spaced apart (e.g., spaced, apart and/or separated) from the other case short side 1301. In one or more embodiments, the negative electrode side retainer 142 may loosely contact the other case short side 1301 (e.g., a side of the negative electrode retainer 142 adjacent the other case short side 1301 may partially or not fully contact the other case short side 1301). In one or more embodiments, the vertical length of the negative electrode side retainer 142 may be smaller than the vertical length of the negative electrode current collector plate 122. In one or more embodiments, the vertical length of the negative electrode side retainer 142 may be equal to or greater than the vertical length of the negative electrode current collector plate 122. The negative electrode side retainer 142 may also be referred to as a negative electrode insulator, a negative electrode elastomer, a negative electrode spacer, or a negative electrode stopper. The negative electrode side retainer 142 may basically prevent or reduce the negative electrode current collector plate 122 and/or the electrode assembly 110 from directly contacting or short-circuiting the other case short side 1301. The negative electrode side retainer 142 ignites and expands upon external impact, thereby preventing or reducing the negative electrode current collector plate 122 and/or the electrode assembly 110 from directly contacting the other case short side 1301. In one or more embodiments, a plurality of negative electrode side ignition devices 1421 may be arranged inside the negative electrode side retainer 142.

The bottom retainer 143 (optional) may be positioned horizontally in a gap between the assembly bottom 1104 and the case bottom 1304. In one or more embodiments, the bottom retainer 143 may be coupled to the assembly bottom 1104 by a mechanical structure in an insulated state. In one or more embodiments, the bottom retainer 143 may contact the assembly bottom 1104 and may be spaced apart (e.g., spaced, apart and/or separated) from the case bottom 1304. In one or more embodiments, the bottom retainer 143 may loosely contact the case bottom 1304 (e.g., a side of the bottom retainer 143 adjacent the case bottom 1304 may partially or not fully contact the case bottom 1304). In one or more embodiments, the horizontal length of the bottom retainer 143 may be smaller than the horizontal length of the assembly bottom 1104. In one or more embodiments, the horizontal length of the bottom retainer 143 may be equal to or greater than the horizontal length of the assembly bottom 1104. The bottom retainer 143 may also be referred to as a bottom insulator, a bottom elastomer, a bottom spacer, or a bottom stopper. The bottom retainer 143 may basically prevent or reduce the assembly bottom 1104 from directly contacting or short-circuiting the case bottom 1304. The bottom retainer 143 may ignite and expand upon external impact, thereby preventing or reducing the electrode assembly 110 from directly contacting the case bottom 1304. In one or more embodiments, a plurality of bottom ignition devices 1431 may be arranged inside the bottom retainer 143.

The cap plate 150 may be coupled to the case 130. The cap plate 150 may be laser welded to a pair of case short sides 1301 and a pair of case long sides 1302, respectively. The cap plate 150 may protect the electrode assembly 110 located inside the case 130 together with the case 130, the positive electrode current collector plate 121, the negative electrode current collector plate 122, the positive electrode side retainer 141, the negative electrode side retainer 142 (and the bottom retainer 143), and an electrolyte from external environments and may prevent or reduce the internal electrolyte from leaking to the outside. The cap plate 150 may be referred to as a lid, a cover, or a cap assembly. The cap plate 150 may include aluminum, an aluminum alloy, nickel, a nickel alloy, or nickel-plated steel. In one or more embodiments, the cap plate 150 may further include a liquid injection port plug 151 coupled to the liquid injection port and a safety vent 152 coupled to the vent hole. In one or more embodiments, the cap plate 150 may have a positive electrode terminal 161 and a negative electrode terminal 162 coupled thereto.

The positive electrode terminal 161 may be electrically connected to the positive electrode current collector plate 121 located inside the case 130 and may be coupled thereto while passing through the cap plate 150. In one or more embodiments, the positive electrode terminal 161 may penetrate the cap plate 150 with the positive electrode side insulation gasket 1611 interposed therebetween. In one or more embodiments, the positive electrode terminal 161 may be electrically shorted (e.g., connected) with the cap plate 150 so that the case 130 and the cap plate 150 also have a positive polarity. The positive electrode terminal 161 may include aluminum or an aluminum alloy.

The negative electrode terminal 162 may be electrically connected to the negative electrode current collector plate 122 located inside the case 130 and may be coupled thereto while passing through the cap plate 150. In one or more embodiments, the negative electrode terminal 162 may penetrate the cap plate 150 with the negative electrode side insulation gasket 1621 interposed therebetween. The negative electrode terminal 162 may include aluminum, an aluminum alloy, copper, a copper alloy, or nickel-plated steel.

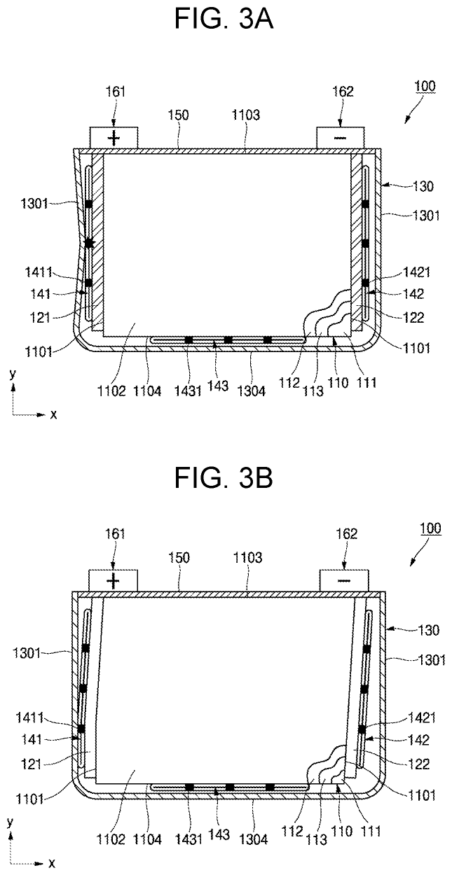

FIGS. 3A and 3B are schematic cross-sectional diagrams showing the operation of an example secondary battery 100 according to one or more embodiments of the present disclosure. In one or more embodiments, a gap may exist between case 130 and electrode assembly 110 of the battery 100. In the related art, the gap between the case long side 1302 and the assembly long side 1102 is removed by a swelling phenomenon of the electrode assembly 110 that occurs during charging and discharging of the battery after the assembly process. However, the gap between the case short side 1301 and the assembly short side 1101 and/or the gap between the case bottom 1304 and the assembly bottom 1104 still exist even when charging and discharging the battery after the assembly process. This is because that the swelling phenomenon of the electrode assembly 110 mainly occurs between the pair of assembly long sides 1102 and relatively minor expansion occurs between the pair of assembly short sides 1101 and/or between the assembly bottom 1103 and the assembly-upper side 1103.

In one or more embodiments of the present disclosure, the retainer (the positive electrode side retainer 141, the negative electrode side retainer 142, and/or the bottom retainer 143) may operate as soon as the gap between the electrode assembly 110 and the case 130 disappears and an external force or impact greater than a reference value is applied.

In one or more embodiments, there may be approximately (about) two conditions under which the internal gap of the case 130 disappears and the retainer operates. First, as shown in FIG. 3A, buckling occurs due to an external force acting from the outside of the case 130, causing some regions of the case 130 to deform inward. Second, as shown in FIG. 3B, when an external impact occurs to a battery, the electrode assembly 110 contacts the case 130 due to the inertial movement of the electrode assembly 110.

In one or more embodiments, the gap between retainers 141, 142, 143 and the case 130 may be approximately (about) 1 mm to approximately (about) 10 mm. If (e.g., when) the gap is less than approximately (about) 1 mm, it is difficult to assemble the electrode assembly 110 including the current collector and the retainer into the case 130, and if (e.g., when) the gap is greater than approximately (about) 10 mm, the internal space efficiency of the case 130 is small and the inertial shock increases.

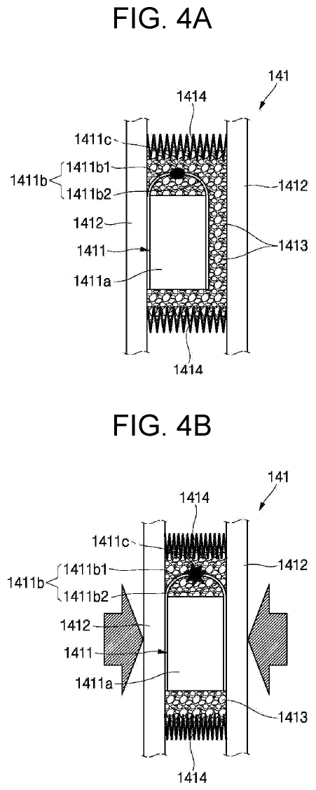

FIGS. 4A and 4B are schematic diagrams showing the configuration and operation of a retainer of an example secondary battery 100 according to one or more embodiments of the present disclosure. Here, the retainer may include the positive electrode side retainer 141, the negative electrode side retainer 142, and/or the bottom retainer 143. Here, the description will be given by using the positive electrode side retainer 141 as an example.

As shown in FIGS. 4A and 4B, the retainer 141 may include an ignition device 1411, a plate structure 1412, and a gas generating agent 1413. In one or more embodiments, the retainer may further include an elastic member 1414.

The ignition device 1411 may include a piezoelectric element 1411a, a spark generating circuit 1411b, and an igniter 1411c. The ignition device 1411 may also be referred to as a detonator. The piezoelectric element 1411a may generate an electrical signal when receiving a mechanical external force (for example, compression or tension). The spark generating circuit 1411b may include a positive electrode circuit 1411b1 attached to one side of the piezoelectric element 1411a and a negative electrode circuit 1411b2 attached to the other side of the piezoelectric element 1411a, and the end of the positive electrode circuit 1411b1 and the end of the negative electrode circuit 1411b2 may be spaced and/or apart (e.g., spaced, apart and/or separated) by a certain distance (for example, approximately (about) 0.1 mm to approximately (about) 5 mm). The igniter 1411c may be coupled to the spark generating circuit 1411b. In one or more embodiments, the igniter 1411c may be coupled to the ends of (e.g., one end of each of) the positive electrode circuit 1411b1 and the negative electrode circuit 1411b2. In one or more embodiments, when the piezoelectric element 1411a operates and a spark is generated between the end of the positive electrode circuit 1411b1 and the end of the negative electrode circuit 1411b2, the igniter 1411c may ignite and explode, generating high heat.

The plate structure 1412 may be located outside the ignition device 1411, and one side may face the electrode assembly 110 and the other side may face the case 130. In one or more embodiments, some regions of the plate structure 1412 may be coupled to one of the current collector plates 121 or 122 or the electrode assembly 110, and other regions of the plate structure 1412 may face the case 130. In one or more embodiments, the plate structure 1412 may include a nylon, a polyester, a polypropylene, or a polyethylene that does not react with an electrolyte. The plate structure 1412 may be referred to as a housing, a case, or an exterior material. In one or more embodiments, the ignition device 1411 may be attached to a portion of the plate structure 1412.

The gas generating agent 1413 may be disposed in a capsule form inside the plate structure 1412, for example, around the ignition device 1411. The gas generating agent 1413 may include a plurality of sodium azide (NaN₃) capsules and iron oxide (Fe₂O₃). Until the operation of the ignition device 1411, the sodium azide (NaN₃) capsules and iron oxide (Fe₂O₃) are physically and chemically separated from each other. In one or more embodiments, when high heat is generated by the ignition device 1411, the sodium azide capsules may melt and the sodium azide may react with iron oxide to generate nitrogen gas. Accordingly, the volume of the retainer 141 expands and elastically fills the gap between the electrode assembly 110 and the case 130, thereby preventing or reducing the electrode assembly 110 from directly colliding with the case 130.

The elastic member 1414 may be coupled within a pair of plate structures 1412. In one or more embodiments, two to five elastic members 1414 may be installed around the ignition device 1411. In one or more embodiments, the elastic member 1414 may include (e.g., be) a spring and/or a rubber. In one or more embodiments, the thickness or length of the elastic member 1414 may be greater than the thickness or length of the ignition device 1411, respectively.

In this way, when an impact is applied from the outside of the secondary battery 100, the pair of plate structures 1412 may press the elastic member 1414 and may ultimately press the ignition device 1411. The ignition device 1411 generates a spark to cause the gas generating agent 1413 filled inside the plate structure 1412 to operate, and accordingly, a large amount of nitrogen gas is generated from the gas generating agent 1413 to expand the retainer 141, 142 or 143. Therefore, when the secondary battery 100 is subjected to external impact, the retainers 141, 142, or 143 may expand to prevent or reduce the electrode assembly 110 from colliding with the case 130.

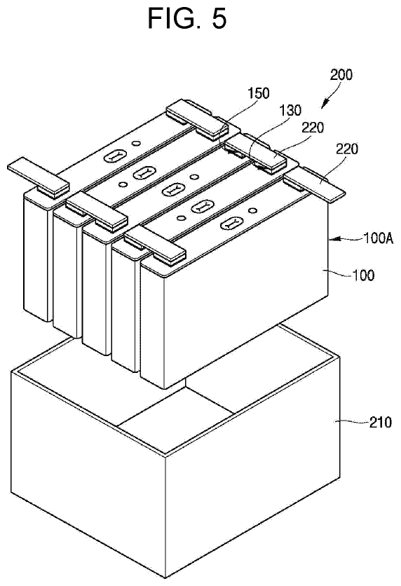

FIG. 5 is a schematic perspective diagram illustrating an example battery pack to which an example secondary battery according to of or more embodiments of the present disclosure is applied. Referring to FIG. 5, the battery pack according to one or more embodiments of the present disclosure may include an assembly 100A in which individual secondary batteries are electrically connected through a bus bar 220 and a pack housing 210 accommodating the same. Additional elements, such as a cooling unit, external terminals, and battery monitoring system, may also be included.

The battery pack 200 may be mounted on the vehicle 300. The vehicle 300 may be, for example, an electric vehicle, a hybrid vehicle, or a plug-in hybrid vehicle. The vehicle may include a four-wheeled vehicle or a two-wheeled vehicle.

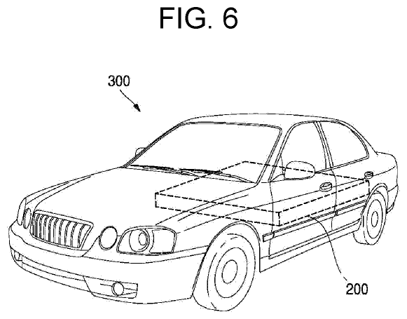

FIG. 6 is a schematic perspective diagram showing an electric vehicle to which an example battery pack according to one or more embodiments of the present disclosure is applied. As shown in FIG. 6, a vehicle 300 according to one or more embodiments of the present disclosure may include an example battery pack 200 according to one or more embodiments of the present disclosure. The vehicle 300 may operate by receiving power from the battery pack 200 according to one or more embodiments of the present disclosure.

As described above, the present disclosure can provide a secondary battery in which a retainer that ignites and expands upon external impact is positioned in a gap between the electrode assembly and the case, thereby protecting the electrode assembly from external impact.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Further, the use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The portable device, vehicle, the battery, e.g., a battery controller, the ignition device, the spark generating circuit and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

What is claimed is:

1. A secondary battery comprising:
an electrode assembly comprising a positive electrode plate and a negative electrode plate;
a positive electrode current collector plate electrically connected to the positive electrode plate;
a negative electrode current collector plate electrically connected to the negative electrode plate;
a case accommodating the electrode assembly, the positive electrode current collector plate, and the negative electrode current collector plate;
a positive electrode retainer in a gap between the positive electrode current collector plate and the case, the positive electrode retainer being to ignite and expand upon external impact; and
a negative electrode retainer in a gap between the negative electrode current collector plate and the case, the negative electrode retainer being to ignite and expand upon external impact.

2. The secondary battery as claimed in claim 1, wherein the electrode assembly comprises a pair of opposing assembly short sides and a pair of assembly long sides connected to the pair of assembly short sides,
the case comprises a pair of opposing case short sides and a pair of case long sides connected to the pair of case short sides,
the positive electrode current collector plate is between one assembly short side and one case short side, and
the negative electrode current collector plate is between the other assembly short side and the other case short side.

3. The secondary battery as claimed in claim 2, wherein the positive electrode retainer is between the positive electrode current collector plate and the one case short side, and
the negative electrode retainer is between the negative electrode current collector plate and the other case short side.

4. The secondary battery as claimed in claim 2, wherein:
the electrode assembly further comprises an assembly bottom connecting the pair of assembly short sides and the pair of assembly long sides,
the case further comprises a case bottom connecting the pair of case short sides and the pair of case long sides, and
a bottom retainer is in a gap between the assembly bottom and the case bottom, the bottom retainer being to ignite and expand upon external impact.

5. The secondary battery as claimed in claim 1, wherein each of the positive electrode retainer and the negative electrode retainer comprises:
an ignition device;
a pair of plate structures outside the ignition device, one plate structure facing the electrode assembly and the other plate structure facing the case; and
a gas generating agent around the ignition device inside the pair of plate structure.

6. The secondary battery as claimed in claim 5, wherein the ignition device is attached to either one of the pair of plate structures.

7. The secondary battery as claimed in claim 5, wherein the pair of plate structures comprises nylon, polyester, polypropylene, and/or polyethylene.

8. The secondary battery as claimed in claim 5, wherein the ignition device comprises:
a piezoelectric element;
a spark generating circuit electrically connected to opposite sides of the piezoelectric element; and
an igniter connected to the spark generating circuit.

9. The secondary battery as claimed in claim 5, further comprising at least one elastic member within the pair of plate structures.

10. The secondary battery as claimed in claim 9, wherein the elastic member comprises a spring and/or a rubber.

11. The secondary battery as claimed in claim 5, wherein the pair of plate structures is to press the ignition device upon external impact.

12. The secondary battery as claimed in claim 5, wherein the gas generating agent comprises a sodium azide (NaN₃) capsule and iron oxide (Fe₂O₃).

13. The secondary battery as claimed in claim 4, wherein the bottom retainer comprises:
an ignition device;
a pair of plate structures outside the ignition device, one side facing the electrode assembly and the other side facing the case; and
a gas generating agent around the ignition device inside the pair of plate structures.

14. The secondary battery as claimed in claim 13, wherein the ignition device is attached to either one of the pair of plate structures.

15. The secondary battery as claimed in claim 13, wherein the pair of plate structures comprises nylon, polyester, polypropylene, and/or polyethylene.

16. The secondary battery as claimed in claim 13, wherein the ignition device comprises:
a piezoelectric element;
a spark generating circuit electrically connected to opposite sides of the piezoelectric element; and
an igniter connected to the spark generating circuit.

17. The secondary battery as claimed in claim 13, further comprising at least one elastic member within the pair of plate structures.

18. The secondary battery as claimed in claim 17, wherein the elastic member comprises a spring and/or a rubber.

19. The secondary battery as claimed in claim 13, wherein the pair of plate structures is to press the ignition device upon external impact.

20. The secondary battery as claimed in claim 13, wherein the gas generating agent comprises a sodium azide (NaN3) capsule and iron oxide.
